(19) United States
(12) Patent Application Publication
(10) Pub. No.: US 2015/0191084 A1
(43) Pub. Date: Jul. 9, 2015

(54) METHOD FOR OPERATING A DRIVER ASSISTANCE SYSTEM FOR A VEHICLE AND DRIVER ASSISTANCE SYSTEM FOR A VEHICLE

(71) Applicant: Robert Bosch GmbH, Stuttgart (DE)

(72) Inventor: Thomas Fuehrer, Stuttgart-Weillimdorf (DE)

(73) Assignee: Robert Bosch GmbH, Stuttgart (DE)

(21) Appl. No.: 14/414,295

(22) PCT Filed: Jul. 4, 2013
(86) PCT No.: PCT/EP2013/064096

§ 371 Date: Jan. 12, 2015

(30) Foreign Application Priority Data
Jul. 11, 2012 (DE) 10 2012 212 065.3

(51) Int. Cl. B60K 35/00; B60W 30/17; B60W 50/14; B60W 30/12

(52) U.S. Cl. CPC B60K 35/00; B60W 30/12; B60W 30/17; B60W 50/14; B60K 2350/1076; B60K 2350/1096; B60K 2350/962; B60W 2050/146; B60W 2550/20; B60W 2550/12

(57) ABSTRACT

A method for operating a driver assistance system for a vehicle, the driver assistance system including a congestion assistant for guiding the vehicle during a traffic jam; and an operating state of the congestion assistant being recorded; information linked to the surroundings of the vehicle being provided as a function of the recorded operating state of the congestion assistant. In particular, additional information is provided if the congestion assistant is guiding the vehicle. The driver is then able to direct his attention away from the traffic and to this information, without danger. Further described is a corresponding driver assistance system and computer program.

### FIELD OF THE INVENTION

The present invention relates to a method for operating a driver assistance system for a vehicle. The present invention also relates to a driver assistance system for a vehicle. Furthermore, the present invention relates to a computer program.

### BACKGROUND INFORMATION

Driver assistance systems for vehicles as such are already known. These usually provide the driver of a vehicle with information on the surroundings of the vehicle.

It is believed to be desirable that the provision of the information support the driver in a meaningful way during his guidance of the vehicle, so that he can guide the vehicle through the traffic safely and efficiently.

### SUMMARY OF THE INVENTION

An object on which the present invention is based may be seen in providing a method for operating a driver assistance system for a vehicle, which enables efficient and safe vehicle guidance.

The object on which the present invention is based may also be seen as providing a corresponding driver assistance system for a vehicle.

The object on which the present invention is based may also be seen in stating a corresponding computer program.

These objects are attained by the respective subject matter of the independent claims. Advantageous embodiments are the subject matter of the respective dependent claims.

According to one aspect, a method for operating a driver assistance system of a vehicle is provided. The driver assistance system includes a congestion assistant for guiding the vehicle during a traffic jam. It is provided that an operating state of the congestion assistant is recorded and, as a function of the recorded operating state, information linked to the surroundings of the vehicle is provided.

According to another aspect, a driver assistance system for a vehicle is provided. The driver assistance system includes a congestion assistant for guiding the vehicle during a traffic jam. Moreover, a providing device for making available information linked to the surroundings of the vehicle is provided. Furthermore, the driver assistance system includes a control device for controlling the providing device as a function of an operating state of the congestion assistant, the control device being in particular configured to record the operating state of the congestion assistant.

According to another aspect, a computer program is provided, which includes the program code to execute the method for operating a driver assistance system for a vehicle when the computer program is run on a computer.

Because the providing of information as a function of the detected operating state of the congestion assistant is carried out, it is advantageously effected that the information is only provided when the congestion assistant is in a certain operating state. Consequently, situations may be avoided in an advantageous manner in which providing the information is not meaningful, and it would only distract the driver unnecessarily from guiding the vehicle.

Because the information is linked to the surroundings of the vehicle, the driver advantageously receives information on the surroundings of the vehicle and, this being the case, is able to take this information into account in a vehicle guidance. For this reason, a vehicle guidance may advantageously be carried out particularly safely, so that traffic flow is optimized in an advantageous manner. This happens because, based on the efficient vehicle guidance on the part of the driver, because of the provided information with respect to the surroundings of the vehicle, the driver is able to optimize his own behavior in the traffic flow. Thus he is able to decide, for instance, based on the provided information, that it is more meaningful to leave the route, so that after leaving it, the number of vehicles on the route has been reduced, which will advantageously favor, or rather speed up the resolution of the traffic congestion.

A traffic congestion within the meaning of the present invention may also be designated as a traffic jam, and as a rule it designates a severely congested traffic flow or one that has come to a standstill on a route such as a road. This then means, in particular, that a number of vehicles per time unit or per route length is greater than a predetermined threshold value. A traffic jam is especially at hand if the traffic, that is, the vehicles flow at a speed of less than 40 km/h, particularly less than 20 km/h, which may be less than 12 km/h. The term traffic jam, as it is used at present, includes both the traffic flow that has come to a standstill and the greatly congested traffic flow.

A congestion assistant within the meaning of the present invention designates particularly a system which is configured to guide the vehicle partially autonomously and/or autonomously, that is, fully autonomously, when there is a traffic jam or congested traffic flow. A congestion assistant may include an automatic speed control and/or a lane keeping assistant for guiding the vehicle in a lane and/or an automatic steering-angle control. This then particularly means that a congestion assistant within the meaning of the present invention is configured to intervene in a longitudinal or transverse guidance of the vehicle and to regulate it, automatically and at least partially autonomously, which may be autonomously.

According to one specific embodiment, it may be provided that the information is provided if the operating state is an active operating state, in which the congestion assistant guides the vehicle at least partially autonomously, which may be autonomously. This means then, in particular, that the control device is configured correspondingly, so that the providing device provides the information only if the operating state is an active operating state, in which the congestion assistant guides the vehicle at least partially autonomously, which may be autonomously.

This then means especially that, according to the abovementioned specific embodiment, the information is provided only if there is a traffic jam or a congested traffic flow in which the congestion assistant is guiding the vehicle, since otherwise the congestion assistant would not be in an active operating state. In such a situation, a driver is able to pick up and process the provided information without curtailing vehicle safety all that much.

As a rule, to be sure, he is distracted from the traffic for a brief moment, by this activity. However, this is usually compensated for in that the congestion assistant guides the vehicle at least partially autonomously, which may be autonomously.

In one specific embodiment it may be provided that the information is information selected from the specified group of types of information: geographic information, historical information, cultural information, social information, political information, commercial information.

This then means in particular that the driver advantageously receives far-reaching data on the surroundings of the vehicle. This being the case, he is able to optimize his driving behavior still further.

In another specific embodiment, it may be provided that several types of information are provided. The data may be formed to be equal or particularly different.

According to another specific embodiment, it may be provided that the information be further provided selected as a function of a parameter from the following group of parameters: duration of the traffic jam in time, length of the traffic jam, length of stay in the traffic jam, distance and/or driving time to an exit point, distance and/or driving time to a parking lot, destination position of a current route of the vehicle, destination position of a route of the vehicle older in time, prospective range of the vehicle, weather parameters.

It may be provided that the information be provided as a function of several of the abovementioned parameters. The parameters may be formed in this instance to be equal or different.

By providing the parameter, which is a necessary condition for the information being provided, situations may be avoided in which it is not meaningful to provide the information. Thus, as a rule, it is not meaningful to provide the information if a duration in time of the traffic jam amounts to only two minutes. In this case, the driver would be unnecessarily distracted from the traffic. Based on the short duration in time, it is also not meaningful, as a rule, to take measures for optimizing behavior in the traffic jam. On the other hand, it may be meaningful to provide the driver with the data if a distance and/or a driving time to an exit point lie below a predetermined threshold value. In such a case it is worthwhile to leave the original route, in order to make a detour around the traffic jam, for example.

According to one further specific embodiment, it may be provided that the identity of a passenger of the vehicle be recorded, and the information be selected from a quantity of data as a function of person-related data of the identified passenger of the vehicle. This makes it advantageously possible that, tailored to the identified vehicle passenger, specific information of a quantity of data types is provided. The person-related data may be included, for instance, in a personal user profile of the vehicle passenger in a social network. This then means particularly that the provided information is provided as a function of personal preferences of the vehicle passenger. To a vehicle passenger who is a football fan, for example, information is usually provided on a close-by football stadium, relative to the instantaneous vehicle position, if the vehicle is located in a traffic jam. The vehicle passenger may thus decide whether he would prefer to visit the football stadium to waiting in the traffic jam. He is thus able to use the time in a sensible manner.

According to one further specific embodiment, it may be provided that the information is checked by a cloud server. The term cloud server denotes particularly a server situated externally in front of the vehicle, a communication between the vehicle and the cloud server being usually carried out using a wireless communication method. In this case, we are discussing a radio communications method or a WLAN communications method. The communication may be carried out in encrypted manner. Because the information is solicited from a cloud server, no local data bank has to be provided locally in the vehicle, including a large number of data. Data on a cloud server are usually more current than locally stored data.

According to one specific embodiment, the providing device may include a screen. The providing device is able to include a projection system for projecting the provided information on a window pane, which may be the windshield of the vehicle. The providing device may include a screen of a mobile telephone.

The present invention will be explained in greater detail in the following text with reference to exemplary embodiments.

BRIEF DESCRIPTION OF THE DRAWINGS

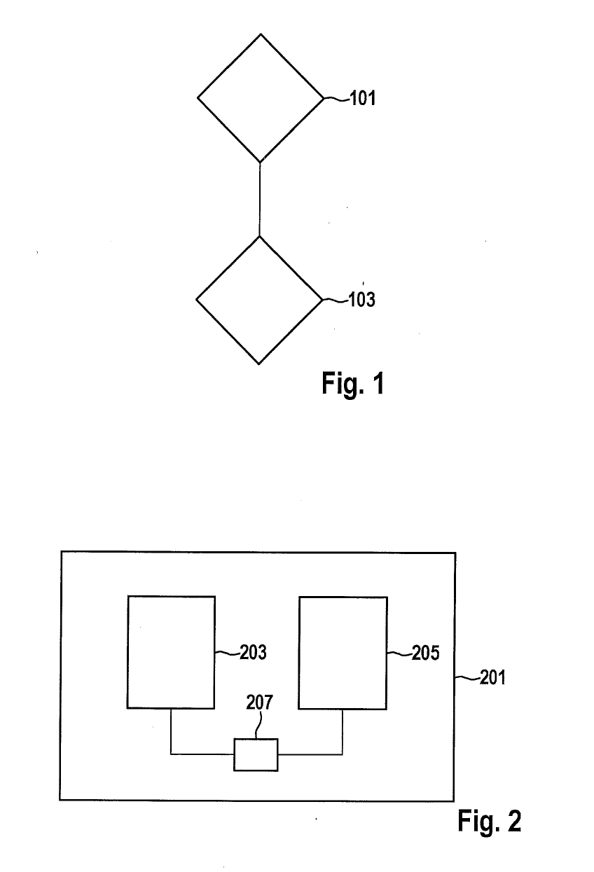

FIG. 1 shows a flow chart of a method for operating a driver assistance system of a vehicle.

FIG. 2 shows a driver assistance system for a vehicle.

### DETAILED DESCRIPTION

FIG. 1 shows a method for operating a driver assistance system for a vehicle.

The driver assistance system includes a congestion assistant for guiding the vehicle during a traffic jam. According to a step 101, an operating state of the congestion assistant is recorded. In accordance with the recorded operating state, in a step 103, information is provided which is linked to the surroundings of the vehicle.

It may be provided that the information be provided only if the operating state of the congestion assistant is an active operating state, in which the congestion assistant guides the vehicle at least partially autonomously, which may be autonomously.

According to one specific embodiment that is not shown, it may be provided that the identity of a vehicle passenger is recorded. This recording may be carried out, for example, using face recognition. This information may be selected from a quantity of information, as a function of person-related data of the identified vehicle passenger.

FIG. 2 shows a driver assistance system 201 for a vehicle (not illustrated). Driver assistance system 201 includes a congestion assistant 203 for guiding the vehicle during a traffic jam. Furthermore, a providing device 205 is provided, which is able to provide information that is linked to the surroundings of the vehicle. In addition, driver assistance system 201 includes a control device 207 for controlling providing device 205 as a function of an operating state of congestion assistant 203. In this instance, it may be provided that control device 207 is configured to record the operating state of congestion assistant 203. For this, in particular, a recording device may also be provided which is connected to control device 207.

Control device 207 may be configured to control providing device 205 in such a way that the latter provides the information only if the operating state of congestion assistant 203 is an active operating state, in which congestion assistant 203 guides the vehicle at least partially autonomously, which may be autonomously, that is, fully autonomously.

In one specific embodiment that is not shown, it may be provided that congestion assistant 203 includes one or more radar sensors and/or one or more video cameras. Using the appropriate data of the sensors and the camera, congestion assistant 203 is thus advantageously able to ascertain data with respect to distances between vehicles, data with respect to traffic lanes and data with respect to detected vehicles, from which a traffic jam density is able to be ascertained.

Congestion assistant 203 may be able to communicate with a cloud server, in order to obtain from the latter information with respect to a traffic state, especially as to whether there is a traffic jam or not. In this case it may be provided, for example, that a social network is provided, the individual participants of the social network exchanging among one another information with respect to the traffic, for instance, a driving time in the traffic jam.

Moreover, it may be provided that the current destination and/or earlier destinations, as well as the instantaneous location or position, a personal profile of the driver, such as cultural preferences, product data, travel destinations, offers and/or sports interests are recorded.

It may be provided that the individual abovementioned items of information or sensor-recorded data be combined with one another, so that location-related and/or requirement-related pointers from the data banks and the social networks of the Internet with respect to geography, history, culture, social matters, politics and/or commerce is able to be requested or inquired about, evaluated and prepared. The prepared information may be coordinated with personal wishes and behavior of a driver or a vehicle passenger. Such personal wishes and manners of behavior are usually known from social networks or the person's surfing behavior on the Internet.

The information personalized from this is provided. This providing is done, in particular, using a screen, also called a display in English, which may be a navigation display or a head-up display in the vehicle. It may be provided alternatively or supplement that the provided information will be provided using a mobile radio telephone of the driver and/or of a vehicle passenger. That is to say, in particular, the provided information is sent or transferred for display to the mobile radio telephone and shown there. The provided information may particularly refer to real places, such as a town, a monument, a river or meadows, which may then be suggested particularly as a possible destination of a navigation.

In this instance, it may be provided that, in the case of these suggestions, an original target of the vehicle, i.e. an original destination point, be taken into consideration. It may be provided that in this case a duration in time of the traffic jam, possible exit points and/or parking places be taken into consideration. In particular, it may be provided that the information is provided appropriately dependently, that is to say, is only provided if sufficient parking places are available, or the distance to the next exit point is less than a predetermined distance.

This is used advantageously to provide a possible alternative, to use the drive in the traffic jam or the time in the traffic jam to obtain information on the surroundings of the vehicle. This may particularly act as an alternative to stop the drive in the traffic jam and drive away from the original route.

In one specific embodiment that is not shown, it may be provided alternatively or in supplement that a personalized profile of a driver or a vehicle passenger is used to align certain product interests, such as buying a special vase, with local offers and advertisement involvements of local vendors which are located in the surroundings of the vehicle. Such a local vendor may be, for instance, a glass-blowing shop having a special manufacturing technique and therefore a good quality of vases, if, according to the profile of the driver or the vehicle passenger, he is interested in vases.

In one specific embodiment that is not shown, it may be provided that the analyses carried out and, this being the case, the information provided is also stored in a personal profile of the driver or the vehicle passenger in the cloud or on a cloud server, so that, in an advantageous way, the information will be able to be taken into account for later planning or research, such as one the home computer (PC) in planning the next vacation or shopping trip.

1-8. (canceled)

9. A method for operating a driver assistance system for a vehicle, the method comprising:
guiding the vehicle during a traffic jam with the aid of a congestion assistant of the driver assistance system; and
recording an operating state of the congestion assistant; and
providing information linked to the surroundings of the vehicle being as a function of the recorded operating state of the congestion assistant.

10. The method of claim 9, wherein the information is provided if the operating state is an active operating state, in which the congestion assistant guides the vehicle at least partially autonomously.

11. The method of claim 9, wherein the information includes one of the following information types: geographic information, historical information, cultural information, social information, political information, and commercial information.

12. The method of claim 9, wherein the information is selected as a function of a parameter from at least one of the following: a duration of the traffic jam in time, a length of the traffic jam, the length of stay in the traffic jam, a distance and/or a driving time to an exit point, a distance and/or a driving time to a parking place, a destination position of a current route of the vehicle, a destination position of a route of the vehicle older in time, and a prospective range of the vehicle and weather parameters.

13. The method of claim 9, wherein the identity of a passenger of the vehicle is recorded, and the information is selected from a quantity of data as a function of person-related data of the identified passenger of the vehicle.

14. The method of claim 9, wherein the information is solicited from a cloud server.

15. A driver assistance system for a vehicle, comprising:
a congestion assistant for guiding the vehicle during a traffic jam;
a providing device for providing information that is linked to the surroundings of the vehicle; and
a control device for controlling the providing device as a function of an operating state of the congestion assistant.

16. A computer readable medium having a computer program, which is executable by a processor, comprising:
a program code arrangement having program code for operating a driver assistance system for a vehicle, by performing the following:
guiding the vehicle during a traffic jam with the aid of a congestion assistant of the driver assistance system; and
recording an operating state of the congestion assistant; and
providing information linked to the surroundings of the vehicle being as a function of the recorded operating state of the congestion assistant.
